(19) United States
(12) Patent Application Publication
(10) Pub. No.: US 2025/0162271 A1
(43) Pub. Date: May 22, 2025

(54) METHOD FOR ADDITIVE MANUFACTURING

(71) Applicant: GENERA PRINTER GMBH, Wien (AT)

(72) Inventor: Klaus STADLMANN, Wien (AT)

(73) Assignee: GENERA PRINTER GMBH, Wien (AT)

(21) Appl. No.: 18/992,157

(22) PCT Filed: Jul. 5, 2023
(86) PCT No.: PCT/AT2023/060213

§ 371 Date: Jan. 7, 2025

(30) Foreign Application Priority Data
Jul. 7, 2022 (AT) A50501/2022

(51) Int. Cl. B29D 12/02; B29C 64/124; B29C 64/40; B29L 12/00; B33Y 10/00; B33Y 80/00; G02C 5/00

(52) U.S. Cl. CPC B29D 12/02; B29C 64/124; B29C 64/40; G02C 5/008; B29L 2012/005; B33Y 10/00; B33Y 80/00

(57) ABSTRACT

A component of an eyeglass frame and a method for additive manufacturing of such a component are by stereolithography. The component includes an eyeglass frame with an inner edge. An inner support structure is manufactured together with the eyeglass frame to support the eyeglass frame. The inner support structure of the manufactured component is connected to the inner edge at two opposite points so that the points are supported with respect to one another. The surface of the component has a connection region that is hidden in a use position of the finished eyeglass frame. An outer support structure is provided, which is manufactured together with the component. A connection between the outer support structure and the component is established in the connection region. The manufacturing of the inner support structure is started once the connection between the outer support structure and the component has been established.

### CROSS-REFERENCE TO RELATED APPLICATION

The present application is a National Stage Application of PCT International Application No.: PCT/AT2023/060213 filed on Jul. 5, 2023, which claims priority to Austrian Patent Application A 50501/2022, filed on Jul. 7, 2022, the disclosure of which is incorporated herein by reference in its entirety.

### TECHNICAL FIELD

The invention relates to a method for additively manufacturing a component of an eye-glass structure by means of stereolithography, wherein the component comprises at least one eyeglass frame having an inner edge, wherein an inner support structure for supporting the eye-glass frame is manufactured together with the eyeglass frame, wherein the inner support structure of the manufactured component is connected to the inner edge at least at two opposite points, so that these points are supported with respect to one another, wherein the surface of the component comprises at least one connecting region, wherein the connecting region is concealed in a use position of the finished eyeglass structure, wherein an outer support structure is provided, which is manufactured together with the component, wherein a connection between the outer support structure and the component is created in the connecting region.

### PRIOR ART

It is established to manufacture eyeglass structures by laser sintering. WO 2011/089208A1 discloses a special surface treatment in this context.

Numerous attempts have also been made to manufacture eyeglass structures or their components using stereolithography. In this context, US 2020/0164591 A1 discloses a special geometry to protect mechanical components and in particular edges in the connecting region of a temple during a surface treatment.

### SUMMARY

One disadvantage of the known methods for additively manufacturing a component of an eyeglass structure using stereolithography is the finishing process. This is necessary in order to process the connection points that are unavoidable in this printing process so that they are no longer impeding and, if possible, no longer visible on the finished product. However, this requires different localised processing of the surface, which can therefore only be carried out manually. The required manual processing step is an obstacle to the spread of stereolithography for this application.

It is an object of the invention to eliminate or at least reduce the disadvantages of the prior art.

According to the invention, the manufacture of the inner support structure is started after the connection between the outer support structure and the component has been created. In other words, the outer support structure is first built up to the connecting region. Starting from the connecting region, manufacture of the component begins. At the earliest when the component has been manufactured up to at least one point of the inner edge of the at least one eyeglass frame, the manufacture of the inner support structure can begin starting from and connected to this or another point of the inner edge of the at least one eyeglass frame manufactured up to that point that is available at a later time.

Due to this sequence of manufacture, all outer support structures connected to visible surfaces of the component can be dispensed with. The at least one connecting region can be located outside the visible surfaces of the component. It may be provided that there is no overlap of the at least one connecting region with one of the visible surfaces of the component. In a use position of the manufactured eyeglass structure, the connecting region may, for example, be concealed by a temple or a veneer, e.g. a glued-on metal visor, so that it does not form part of the visible surfaces of the component. A visible surface is understood here to be a surface that preferably only has to fulfil aesthetic or physiological requirements. In other words, the surface of the component of the eyeglass structure produced by stereolithography is not visible in the connecting region, but is veneered or concealed. The connecting region can be provided, for example, on a general functional surface, interface, inner surface, cut surface, contact surface or support surface of the component. The connecting region is used to connect the support structure to the component of the eyeglasses. In the finished eyeglass structure, the connecting region may comprise, for example, a connection to a temple. By making it possible to completely avoid connections to external support structures in the area of the visible surfaces of the component, the final processing of the component can be significantly simplified and optionally completely automated. As the visible surfaces thus comprise no irregularities due to process-related support structures, a high-quality surface can be achieved by uniform surface treatment (washing and/or rinsing and/or grinding) of the visible surfaces. A uniform surface treatment can be carried out without manual work steps or interventions.

In the context of this disclosure, a support structure refers to a structure that is manufactured, e.g. printed, together with the component, but is not part of the component or eyeglass structure. It is a process-related structure that is required, for example, due to layer-by-layer manufacturing when using stereolithography. Support structures can, for example, hold or support sections of the component that are not yet connected due to the layer-by-layer structure at the start of production. They also serve to connect the component to a possible build platform if the component should not be connected directly to the build platform due to its geometry. A support structure can also be referred to as a construction geometry, support geometry or sacrificial geometry. The fact that the support structure is manufactured together with the component does not necessarily mean that each layer has to be manufactured in a single exposure step. A layer of the component can be exposed in a single exposure pass and thus simultaneously with a layer of the support structure or in several exposure passes, whereby, for example, a layer of the component can be exposed first, then, after a pause (for example 100 ms) a layer of the support structure is exposed.

In this disclosure, an inner support structure refers to a support structure that supports at least two different points of the object manufactured by means of additive manufacturing (in this case the component of the eyeglass structure) against each other. Force is thus transmitted within the manufactured object via the inner support structure. In comparison, an outer support structure refers to a support structure with which the manufactured object or an inner support structure is supported against an outer surface not produced as part of the manufacturing process, typically a build platform. A coherent support structure can generally form both an inner support structure and an outer support structure. For example, depending on their direction, forces can act within the manufactured object or on an external surface. For example, an outer support structure can absorb vertical forces that counteract the force of gravity and act on horizontally spaced points of the manufactured object so that horizontal force components can be absorbed within the object. This allows deformations and, in particular, different deformations between different sections of the object to be counteracted.

In this context, it is understood that the at least two points at which the inner support structure is connected to the inner edge are arranged opposite each other. Accordingly, such opposite points are not neighbouring. Instead, the tangents at the opposite points of the inner edge should either be parallel and spaced apart or include an angle of at least 30°. The disclosure is not limited to diametrically opposite points where these tangents are parallel and spaced apart, but also covers inner support structures arranged in the manner of angle struts, for example.

The at least two points may, but do not have to, correspond to at least two distinguishable structures. For example, the inner support structure may be formed as a support strut between locations in two or more distinct regions of the inner edge. However, the inner support structure may also, for example, be continuously connected to the inner edge along an arc between the at least two locations or even be continuously connected to the entire inner edge. The connection between the inner support structure and the inner edge at least at two points is present in the manufactured component. A corresponding connection can already be provided in the model of the component to be printed or a small distance between the inner support structure and the inner edge can be provided in the model, which is bridged in places or continuously during manufacture by expansion of the materials.

The inner support structure can be removed from the eyeglass frame after the component of the eyeglass structure has been completed. This removal can be done manually or automatically, for example by pressing it out of the eyeglass frame. The connections between the inner support structure and the eyeglass frame are such that removal of the inner support structure leaves the eyeglass frame and thus the component as a whole undamaged. In addition, no residue from the inner support structure remains on the visible surfaces of the component to which it was never connected. The inner edge of the eyeglass frame-at least in the area where there was a connection with the inner support structure-is not a visible surface, but is concealed by the lens in the use position of the finished eyeglass structure with at least one lens. The inner edge may, for example, comprise a recess or groove, whereby the points at which the inner support structure connects to the inner edge may be located inside the recess or groove, for example in the centre of the groove or at the edge of the groove. Alternatively, the inner edge may comprise a step or be flat instead of a recess or groove, for example. The inner support structure can also connect to the inner edge in these cases.

According to the definitions used herein, eyeglasses comprise an eyeglass structure and at least one eyeglass lens. The eyeglass lens or lenses are usually framed in the finished eyeglass structure. This disclosure relates only to the manufacture of an eyeglass structure. The eyeglass structure comprises at least one eyeglass frame. The eyeglass frame is that part or section of the eyeglass structure that at least partially surrounds at least one lens. An eyeglass frame corresponds to a complete or partial border around at least one lens. The eyeglass structure may comprise one or more components.

For example, the eyeglass frame(s) can be manufactured as one component and two temples can be manufactured as further components and then assembled to form an eyeglass structure. This disclosure relates to that component of an eyeglass structure which comprises at least one eyeglass frame, i.e. for at least one eyeglass lens. This may be the only component of the eyeglass structure or one of several components. Eyeglass structures without temples or with only one temple are also comprised by the present disclosure.

Optionally, the two opposite points may be arranged substantially on a horizontal line during the manufacturing process or an imaginary connecting line can form an angle of less than 60°, in particular less than 45°, with a horizontal line through the two opposite points during the manufacturing process. One object of the disclosure is to increase the stability of the unfinished component during the manufacturing process. It is favourable if a layer of the inner support structure exposed at a certain point in time during the manufacturing process is connected to the inner edge on both sides. This allows thin and thus material-saving support structures to be used, which are themselves subject to as little deformation as possible. The angle formed with the horizontal line also depends on whether the layer exposed during an exposure is itself arranged horizontally or at an angle. The two opposite points can be arranged on a horizontal line at least temporarily, i.e. at least during part of the manufacturing process, in particular before the eyeglass frame in question has been completely manufactured.

The inner support structure may optionally be connected to the inner edge at a plurality of opposite points, wherein the opposite points are each arranged in pairs substantially on a horizontal line during the manufacturing process. For example, the inner support structure may be manufactured from a plurality of parallel support struts or a mesh or grid of support struts.

Optionally, the inner support structure can be manufactured as a continuous disc. This has the advantage that planning the geometry of the inner support structure is simplified. The continuous disc can be continuously connected to the inner edge or comprise connections to the inner edge at regular intervals, for example.

The inner support structure can, for example, essentially take the place of a lens that can later be accommodated in the eyeglass frame. This is a simple way of ensuring that all points with connections to the inner edge are concealed by the lens in the use position of the finished eyeglass structure.

Optionally, at least two inner support structures may be provided within the same eye-glass frame, the inner support structures being connected to the inner edge at respective other opposite points, the two respective opposite points being arranged substantially on a horizontal line during the manufacturing process. The inner support structures can optionally be interconnected. Alternatively, the inner support structures may be formed as separate support structures.

For example, the at least two inner support structures can be arranged substantially parallel in this context and separated by a vertical distance during the manufacturing process. This can reduce the loss of material through the support structures compared to a continuous disc.

The component can optionally comprise two eyeglass frames connected by a bridge. The bridge can optionally also form a nose piece of the eyeglass structure. Each eyeglass frame is designed to accommodate a lens. The component may, for example, be symmetrical with respect to a plane of symmetry passing through the centre of the bridge and substantially normally to the bridge. Each of the two eyeglass frames may be manufactured with a separate inner support structure. The inner support structures of the two eyeglass frames may optionally be connected to each other. Such a connection can be achieved via an outer support structure or via an inner support structure.

In this context, the bridge may be arranged vertically during the manufacturing process or may form an angle of at most 45° with a vertical line. The orientation of the component in space during the manufacturing process can thus be essentially laterally suspended. In other words, the axis with the longest extension of the manufactured component can be essentially vertical. For example, the orientation may be such that an axis through the connecting region and the (anticipated) centre of gravity of the manufactured component includes an axis angle of at most 45° with a vertical line.

The outer support structure may optionally be manufactured so that it is connected to the inner support structure. This allows the inner support structure to be supported externally, e.g. on a build platform. This makes it possible to divert some of the forces acting on the inner support structure, in particular the force of gravity, to the outside.

In this way, the forces to be absorbed by the component can be reduced. The component and the inner support structure may be manufactured from the same material. The material can, for example, be a light-curing material, in particular a material that cures under UV light. In general, the inner support structure can be manufactured from a different material than the component. For example, materials that can be dissolved and washed out by means of a washing process are conceivable. Using the same material simplifies the design and ensures that the plastic and mechanical properties are compatible in every state and that no stresses or unintentional bonding occur, for example. The material can optionally be transparent or coloured.

In an analogous manner and with the same effects and advantages, the invention also relates to a component of an eyeglass structure, wherein the component is produced by means of stereolithography, wherein the component comprises at least one eyeglass frame having an inner edge, wherein an inner support structure is arranged within the eyeglass frame and is connected to the inner edge at least at two opposite points so that these points are supported with respect to one another, wherein the inner support structure is connected to an outer support structure.

In the disclosed component, a connecting line through the two opposite points may be arranged substantially normally to a longitudinal extension of the outer support structure. For example, the outer support structure is optimised for absorbing the force of gravity and the inner support structure is optimised for absorbing forces acting transversely thereto which are to be dissipated within the component to minimise the number of connection points of outer support structures.

As already described in connection with the method and with analogous advantages, it may also be provided in the disclosed component that the inner support structure comprises a continuous disc. Optionally, the inner support structure can also essentially take the place of a lens that can later be accommodated in the eyeglass frame in the disclosed component.

Further, the surface of the component may comprise at least one connecting region, the connecting region being concealed in a use position of the finished eyeglass structure, the outer support structure being connected to the component in the connecting region.

More generally and independently of the features defined above and in the claims, the disclosure also comprises a method for additively manufacturing a component of an eyeglass structure by means of stereolithography, wherein the component comprises at least one eyeglass frame having an inner edge, wherein the surface of the component comprises at least one connecting region, wherein the connecting region is concealed in a use position of the finished eye-glass structure, wherein the component is manufactured starting from the connecting region, wherein, during the manufacturing process, an axis through the connecting region and the (anticipated) centre of gravity of the manufactured component forms an axis angle of at most 45o° with a vertical line, wherein a support structure for supporting the eyeglass frame is manufactured together with the eyeglass frame, wherein the support structure of the manufactured component is connected to the inner edge at least at least one point, wherein a tangent of the inner edge at this point forms an edge angle of at most 45o° with the axis.

The component can connect directly to a build platform in the connecting region or to an outer support structure that is to be prefabricated. The axis angle can be at most 40°, in particular at most 35°, in particular at most 22.5°. The smaller the axis angle, the lower the torque in the connecting region when the component is completed. As the centre of gravity of the unfinished component naturally moves during the manufacturing process, an axis angle other than zero can be favourable. In particular, the contact angle can be at most 40° in particular at most 35° in particular at most 22.5°. The areas of the inner edge defined by the edge angle include at least all vertical lines during the manufacturing process. Support by the support structure at these points primarily absorbs shear forces. One advantage of support in this area is that the spring deflection formed by the unfinished (e.g. not yet fully cured) component is reduced. This can counteract different expansions of the frame parts, which can otherwise occur due to the generally asymmetrical shape of the eyeglass frame with respect to a vertical line. In this variant, the support structure can be an inner support structure or an outer support structure or a combination.

### BRIEF DESCRIPTION OF THE DRAWINGS

The invention will be further described below with reference to particularly preferred embodiments, to which it is not limited, and with reference to the drawings. The drawings show, in detail:

FIGS. 1 and 2, schematically, a component of an eyeglass structure according to a first embodiment example of the present disclosure after completion of the manufacture of the component on a build platform;

FIGS. 3 and 4, schematically, an extended embodiment example with several components of correspondingly several eyeglass structures;

FIG. 5, schematically, a front view of a component of an eyeglass structure according to a third embodiment example;

FIG. 6, schematically, a sectional view of the component according to FIG. 5 along the sectional line VI-VI; and

FIGS. 7 to 9, further views of the component according to FIG. 1 without the build platform.

### DETAILED DESCRIPTION OF THE INVENTION

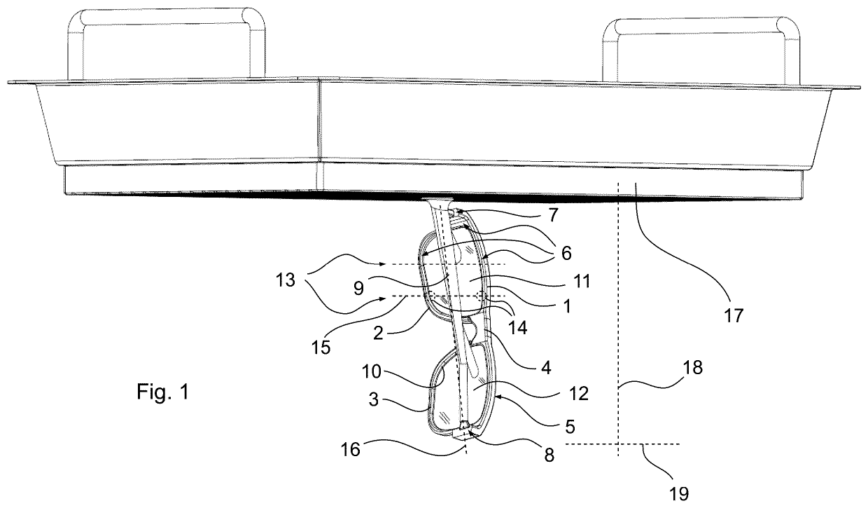

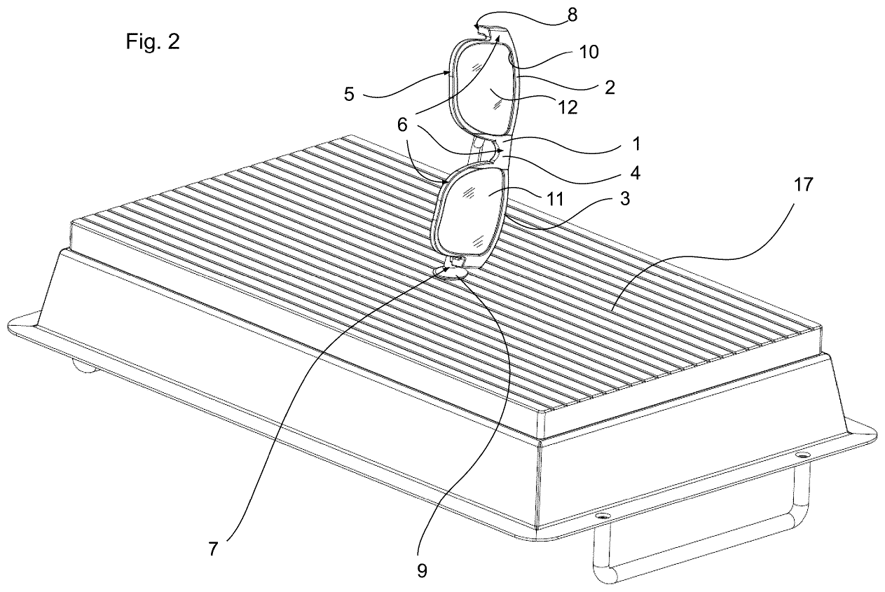

FIG. 1 and FIG. 2 show a component 1 of an eyeglass structure. Component 1 was manufactured using stereolithography. The component 1 comprises two eyeglass frames 2, 3. The two eyeglass frames 2, 3 are connected by a bridge 4. The surface 5 of component 1 comprises visible surfaces 6 and two connecting regions 7, 8. The connecting regions 7, 8 are each used to connect to a temple, e.g. via a hinge. The connecting regions 7, 8 are concealed by the connected temples when the finished eyeglass structure is in a use position. An outer support structure 9 is connected to the component in both connecting regions 7, 8.

Each eyeglass frame 2, 3 comprises an inner edge 10. An inner support structure 11, 12 in the form of a continuous disc is arranged within each of the two eyeglass frames 2, 3. In each case, the inner support structure 11, 12 takes the place of a lens that can later be accommodated in the eyeglass frame 2, 3. The inner support structure 11, 12 is connected all round to the inner edge 10, although the connection may be interrupted in places due to the manufacturing process. The eyeglass frames 2, 3 are therefore supported in themselves over the entire circumference of the inner edge 10. The inner support structure 11, 12 in each of the two eyeglass frames 2, 3 is additionally connected in each case to the outer support structure 9. Both the component 1 itself and the outer support structure 9 and the inner support structures 11,12 are made of the same light-curing material.

Due to the two-dimensional continuity of the two inner support structures 11, 12, several pairs 13 of opposite points 14 can be identified at which the inner support structure 11, 12 is connected to the inner edge 10. In at least some of these pairs 13 of opposite points 14, an imaginary connecting line 15 can be drawn through the two respective opposite points 14, wherein the imaginary connecting line 15 is arranged substantially normally to a longitudinal extension 16 of the outer support structure 9.

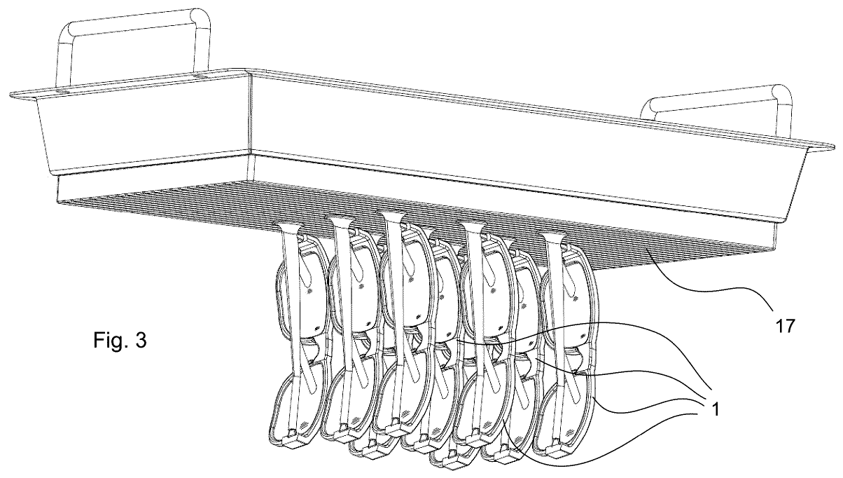

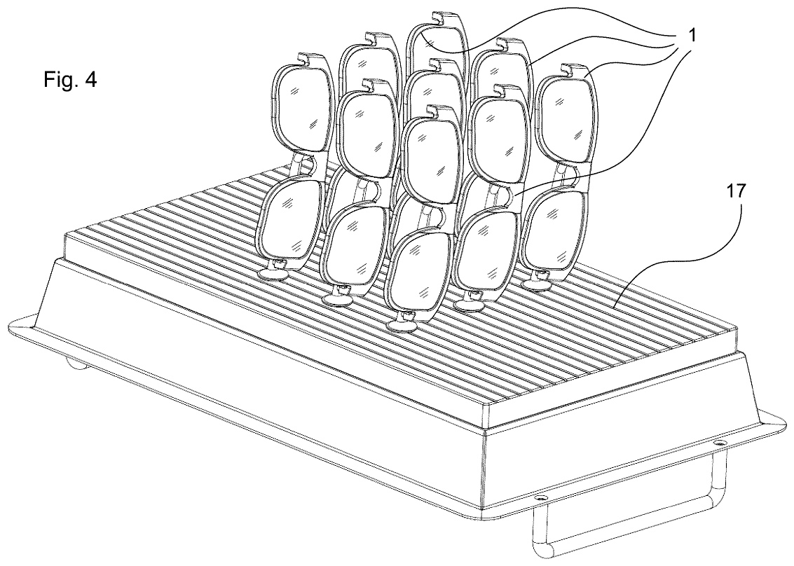

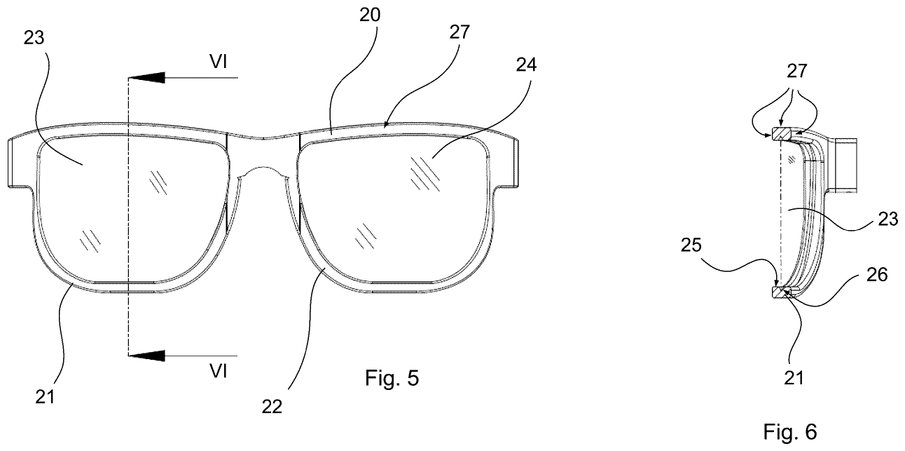

In the position shown in FIG. 1 and FIG. 2, the component 1 is shown hanging or standing on the outer support structure 9 from a build platform 17. In this position, the bridge 4 forms an angle of less than 20° with a vertical line 18. During the manufacturing process, the build platform 17 can lie in a horizontal plane and be moved vertically in steps to produce the individual layers. Accordingly, at least some of the opposite points 14 are arranged in pairs on a horizontal line 19 during the manufacturing process. In FIG. 3 and FIG. 4 it is shown that several components 1, in this example nine, can be manufactured simultaneously in one manufacturing process on the build platform 17. FIG. 5 shows a front view of a component 20 constructed in a similar way to FIG. 1. It is clearly recognisable that an inner support structure 23, 24 is arranged in each of the two eyeglass frames 21, 22, which takes the place of a lens to be subsequently accommodated therein. In the section shown in FIG. 6 along line VI-VI in FIG. 5, it can be seen that the eyeglass frame 21 comprises a groove 26 in the inner edge 25. The inner support structure 23 is connected to the inner edge 25 within the groove 26. The visible surfaces 27 of the component 20 are thus free of connections to the inner support structure 23—and also of any outer support structure (see FIGS. 1-4). In addition, it can be seen in FIG. 6 that the inner support structure 23 comprises a significantly smaller cross-section than the eyeglass frame 21.

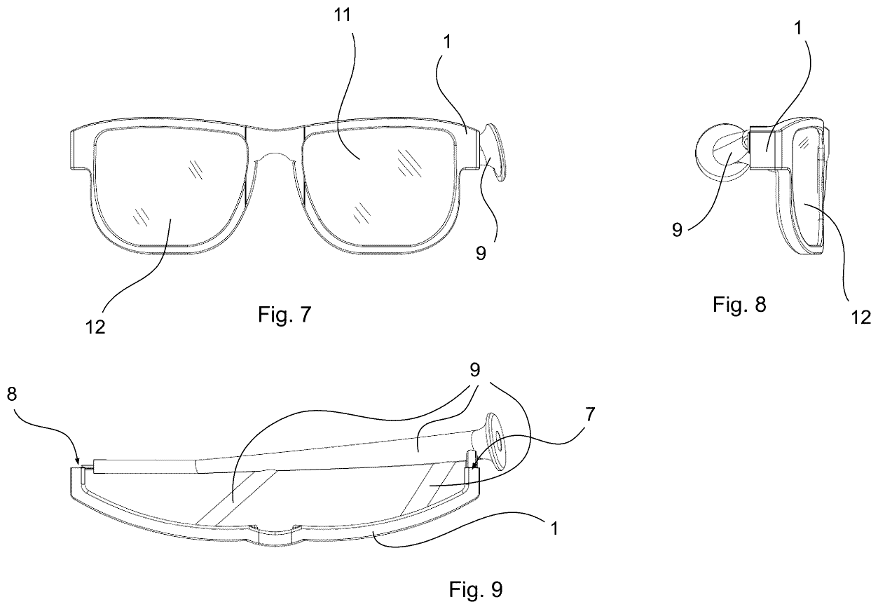

FIGS. 7 to 9 show further views of the component 1 shown in FIGS. 1 and 2 with its inner support structure and outer support structure. In FIG. 9, the shape of the outer support structure 9 and the connecting regions 7, 8 are clearly recognisable.

1. A method for additively manufacturing a component of an eyeglass structure by stereolithography, wherein the component comprises at least one eyeglass frame having an inner edge, wherein an inner support structure for supporting the eyeglass frame is manufactured together with the eyeglass frame, wherein the inner support structure of the manufactured component is connected to the inner edge at least at two opposite points so that the points are supported with respect to one another, wherein the surface of the component comprises at least one connecting region, wherein the connecting region is concealed in a use position of the finished eyeglass structure, wherein an outer support structure is provided, which is manufactured together with the component, wherein a connection between the outer support structure and the component is created in the connecting region,
wherein, manufacturing of the inner support structure is started after the connection between the outer support structure and the component has been created.

2. The method according to claim 1, wherein, the two opposite points are arranged substantially on a horizontal line during the manufacturing or an imaginary connecting line through the two opposite points forms an angle of less than 60°, with a horizontal line during the manufacturing.

3. The method according to claim 1, wherein the inner support structure is connected to the inner edge at a plurality of opposite points, the opposite points being arranged in pairs substantially on a horizontal line during the manufacturing.

4. The method according to claim 1, wherein the inner support structure is manufactured as a continuous disc.

5. The method according to claim 1, wherein the inner support structure is adapted to substantially replace an eyeglass lens configured to be accommodated in the eyeglass frame.

6. The method according to claim 1, wherein at least two inner support structures are provided within a same eyeglass frame of the at least one eyeglass frame, the inner support structures being connected to the inner edge at different opposite points, the two opposite locations being arranged substantially on a horizontal line during the manufacturing.

7. The method according to claim 6, wherein the at least two inner support structures are substantially parallel and are separated by a vertical distance during the manufacturing.

8. The method according to claim 1, wherein the component comprises two eyeglass frames connected by a bridge.

9. The method according to claim 8, wherein the bridge is arranged vertically during the manufacturing or forms an angle of at most 45° with a vertical line.

10. The method according to claim 1, wherein the outer support structure is manufactured so that the outer support structure is connected to the inner support structure.

11. The method according to claim 1, wherein the component and the inner support structure are manufactured from a same material.

12. A stereolithographic component of an eyeglass structure, wherein the component comprises at least one eyeglass frame having an inner edge, wherein an inner support structure is arranged within the eyeglass frame and is connected to the inner edge at least at two opposite points so that the points are supported with respect to one another, wherein the inner support structure is connected to an outer support structure.

13. The component according to claim 12, wherein an imaginary connecting line through the two opposite points is arranged substantially normally to a longitudinal extension of the outer support structure.

14. The component according to claim 12, wherein the inner support structure comprises a continuous disc.

15. The component according to claim 12, wherein the surface of the component comprises at least one connecting region, the connecting region being concealed in a use position of the finished eyeglass structure, the outer support structure being connected to the component in the connecting region.
